(19) United States
(12) Patent Application Publication
(10) Pub. No.: US 2017/0176345 A1
(43) Pub. Date: Jun. 22, 2017

(54) APPARATUS AND METHOD FOR REMOTE DETECTION AND ASSESSMENT OF PROGRESSING DEFORMATION OF UTILITY PIPES AND CULVERTS

(71) Applicant: LINK-TECH. INC., Richmond Hill (CA)

(72) Inventors: Lembit MAIMETS, Toronto (CA); Sinisa STOJICIC, Woodbridge (CA); Marek PACH, Toronto (CA); Nataliya HEARN, Toronto (CA)

(73) Assignee: LINK-TECH INC., Richmond Hill, ON (CA)

(21) Appl. No.: 15/386,677

(22) Filed: Dec. 21, 2016

Related U.S. Application Data
(60) Provisional application No. 62/271,069, filed on Dec. 22, 2015.

(51) Int. Cl. G01N 21/954; G01N 21/88

(52) U.S. Cl. CPC G01N 21/954; G01N 21/8806; G01N 2021/9542; G01N 2201/06113

(57) ABSTRACT

An apparatus for remote detection and assessment of progressing deformation of utility pipes and culverts. The apparatus includes a sensing device configured to acquire information quantifying deformation of a utility pipe or culvert; a communication device connected to the sensing device configured to relay the information of the sensing device to a monitoring station; a plurality of sensor targets in operational communication with the sensing device in a powered-up state of the apparatus, the targets being configured to be fixed in relation to the utility pipe or culvert; and the sensing device being configured to detect a change in a condition or a displacement of at least one of the sensor targets to generate the sensor information.

This application is based upon U.S. Provisional Patent Application No. 62/271,069, filed Dec. 22, 2015, the disclosure of which is hereby incorporated by reference thereto in its entirety, and the priority of which is claimed under 35 USC §119(e).

### BACKGROUND

### Field of the Invention

The invention relates to, without being limited to, an early detection of deformation of utility pipes and culverts which may be indicative of their pending catastrophic failure. More particularly, the invention relates to apparatuses and methods for detecting and analyzing any of various conditions of such pipes and culverts prior to such failure.

### DETAILED DESCRIPTION

The apparatus of the invention includes a sensing device mounted inside a utility pipe or culvert. The device may be connected to a communication device to relay the sensor information to a monitoring station.

A pipe or culvert equipped with the sensing device is configured to alert the monitoring station of a deformation exceeding a predefined threshold level. Optionally, the sensing device may be configured to acquire and send information quantifying the degree of such deformation. The detection of an early stage of the deformation of a pipe or a culvert afforded by the sensing device would be designed to allow timely and targeted application of available technical remedies to the affected site, preventing a possible structural collapse and the resulting material losses.

The sensing device is a common distance laser sensor and two or more distance targets placed in and near the optical path of the distance sensor's laser beam. The distance laser sensor may be equipped with a power supply, a control unit, and an interface to the communication device.

In a particular non-limiting embodiment, the distance sensor can be positioned inside a straight, or substantially straight, section of a utility pipe or a culvert near the upper side of the pipe or culvert, with the laser beam direction being parallel, or substantially parallel, to the longitudinal axis of the pipe. The distance sensor can be mounted with a certain predetermined clearance between the laser beam and the inside surface of the pipe.

The first distance target, henceforth referred to as a primary target, is firmly placed in the laser beam's path at the farthest practical distance from the laser sensor; this distance would be determined either by the sensor's maximum range or by the length of the section of the pipe in need of being instrumented, or by the geometry of the pipe, as the laser beam of the sensor needs to hit the primary target and detect its distance correctly for the sensor to operate.

The distance target could be any piece of opaque material of sufficient reflectivity and size for the distance sensor to register the range. In a non-limiting embodiment, the target can be a brightly painted rigid tab of some arbitrary shape with its flat surface perpendicular to the laser beam.

Further, at least because the invention is disclosed herein in a manner that enables one to make and use it, by virtue of the disclosure of particular exemplary embodiments of the invention, the invention can be practiced in the absence of any additional element or additional structure that is not specifically disclosed herein.

1. An apparatus for remote detection and assessment of progressing deformation of utility pipes and culverts, said apparatus comprising:
a sensing device configured to acquire information quantifying deformation of a utility pipe or culvert;
a communication device connected to the sensing device configured to relay the information of the sensing device to a monitoring station;
a plurality of sensor targets in operational communication with the sensing device in a powered-up state of the apparatus, the targets being configured to be fixed in relation to the utility pipe or culvert; and
the sensing device being configured to detect a change in a condition or a displacement of at least one of the sensor targets to generate the sensor information.

2. An apparatus according to claim 1, further comprising:
a power supply;
a control unit; and
an interface to the communication device.

3. An apparatus according to claim 1, wherein:
the sensing device comprises a distance laser sensor.

4. An apparatus according to claim 3, wherein:
the plurality of sensor targets are laser sensor targets configured to be mounted within the utility pipe or culvert, within and near an optical path of the distance laser sensor.

5. A method of using the apparatus of claim 1 for remote detection and assessment of progressing deformation of a utility pipe or culvert, said method comprising:
affixing the sensing device inside of a section of the utility pipe or culvert;
placing the plurality of sensor targets in operational communication with the sensing device in a powered-up state of the apparatus;
acquiring pipe or culvert deformation information by detecting condition change information; and
relaying said information to the monitoring station.
